(19) United States
(12) Patent Application Publication
(10) Pub. No.: US 2003/0005868 A1
(43) Pub. Date: Jan. 9, 2003

(54) Seed dispenser

(76) Inventors: Georg Jander, Jamaica Plain, MA (US); Narendra S. Kadaba, Newton, MA (US)

Correspondence Address: MONSANTO COMPANY, 800 N. LINDBERGH BLVD., ATTENTION: G.P. WUELLNER, IP PARALEGAL, (E2NA), ST. LOUIS, MO, 63167, US

(21) Appl. No.: 09/897,351

(22) Filed: Jul. 3, 2001

(51) Int. Cl. A01C 7/00

(52) U.S. Cl. 111/186

(57) ABSTRACT

A seed dispensing device comprising an outer tube to hold seed, an inner tube through which an aliquot of seed is dispensed and a closure to secure the inner tube to the outer tube. This device is particularly useful for seed that are small and difficult to handle, e.g. seed of Arabidopsis thaliana. Embodiments of the device provide a means to dispense aliquots of many stocks of seed simultaneously while minimizing cross contamination of the seed stocks.

### BACKGROUND

Arabidopsis seed is very small (about 50,000 seeds per gram) and difficult to handle and dispense. Often cross contamination of seed stocks occurs when a researcher handles more than one stock at a time. Handling one seed stock at a time to avoid cross contamination is very time consuming. It is especially laborious to transfer aliquots of many stocks of small seeds individually. An object of this invention is to provide a dispenser for aliquots of small seeds. A further object of this invention is to provide an apparatus for dispensing multiple aliquots of different seed stocks with little or no cross contamination of the seed stocks.

### SUMMARY OF THE INVENTION

The present invention provides dispensers for aliquots of seed, comprising: (a) a rigid outer tube for holding seed having a round bottom and an open end; (b) a closure for said open end adapted for holding an inner tube; and (c) a straight inner tube for conducting seed from an inside end through said closure to an outside end. When a dispenser is vertically oriented with a quantity of seed at the bottom of the outer tube at a level above the inside end of the inner tube, the dispenser can be repeatedly inverted to dispense aliquots of seeds.

The present invention further provides multi-dispenser apparatus comprising a base with a plurality of wells in a fixed pattern for holding seed dispensers. The present invention further provides apparatus for transferring aliquots of seeds to an array of containers, comprising: (a) a multi-dispenser apparatus and (b) an array of containers in the same pattern as the multi-dispenser and held in alignment with the dispensers The transfer apparatus may comprise a valve box to align a multi-dispenser with an array of containers.

### DRAWINGS

FIGS. 1 and 2 illustrate embodiments of a seed dispenser

FIG. 3 shows a multi-dispenser apparatus

FIG. 4 is an exploded view of a seed transfer apparatus

### DETAILED DESCRIPTION

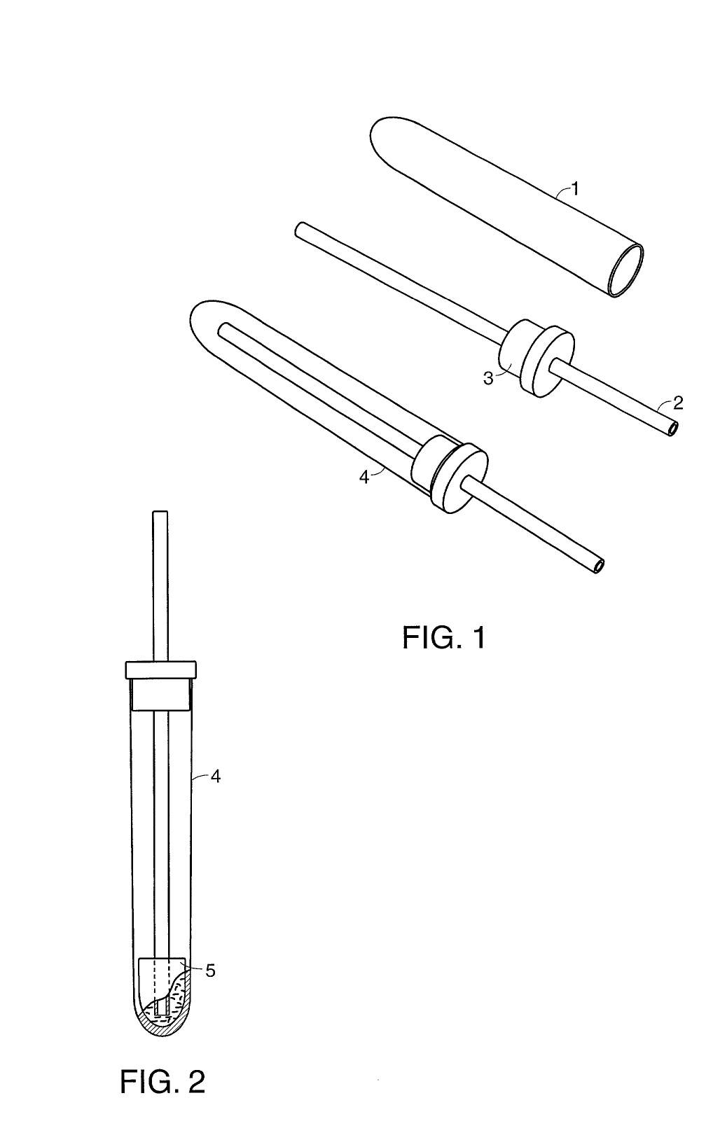

With reference to FIG. 1, there is shown the parts for assembly of a seed dispenser. An outer tube 1 with an open end and a bottom. In preferred embodiments the outer tube is cylindrical and the bottom is a tapered bottom. As used herein, “tapered bottom” includes a v-shaped, e.g. conical bottom and a u-shaped, e.g. round bottom. The outer tube can be selected from a variety of standard glass or plastic tubes available from laboratory supply houses. One particularly useful tube is ScreenMates 1.4 mL tubes catalog number 4140 which is available from Matrix Technologies Corp, Hudson, N.H., USA. The straight inner tube 2 which can be glass, metal or plastic is preferably metal for avoiding static electricity and preferably rigid. The inner tube has two open ends allowing seed to pass through the tube. The diameter of the inner tube must be larger than the nominal dimension of the seed for intended use. For dispensing aliquots of Arabidopsis thaliana seed, a useful inner tube for use with the ScreenMates 1.4 mL outer tubes is cut to a length of 2.50″±.015″ from 304 stainless steel hypotubing (14 RW, WD, .0840/.0820 OD X .0650/.0610 ID, full hard) available from MicroGroup/ALL-TUBE INC., Medway, Mass., USA. The length of the inner tube is not critical provided it can extend from proximate the bottom of the outer tube to a distance beyond the closure. In certain embodiments the inner tube has a length which is between one and two times the length of the outer tube.

A simple embodiment of closure 3 can comprise a rubber or polymeric stopper with a central bore. Other types of closures designed similar to bottle caps or integral with the tube such as a snap top will be readily apparent to those skilled in the art. In a preferred embodiment a polymeric stopper can be molded directly onto the inner tube at a fixed position.

An assembled dispenser 4 will have the inside end of the inner tube 2 proximal to the round bottom of the outer tube 1.

As shown in FIG. 2, a vertically oriented dispenser 4 has a volume of seed 5 at the bottom of the outer tube above the level of the inside end of the inner tube. When the dispenser 4 is inverted, so that it is upside down, an aliquot of seed is dispensed. As used herein “an aliquot of seed” is a quantity of seed which is roughly the same in repetitive dispensings. Preferably the stopper is fixed on the inner tube such that the bottom of the inner tube is at a sufficient distance from the bottom of the outer tube to dispense aliquots of about 5 milligrams of Arabidopsis thaliana seed.

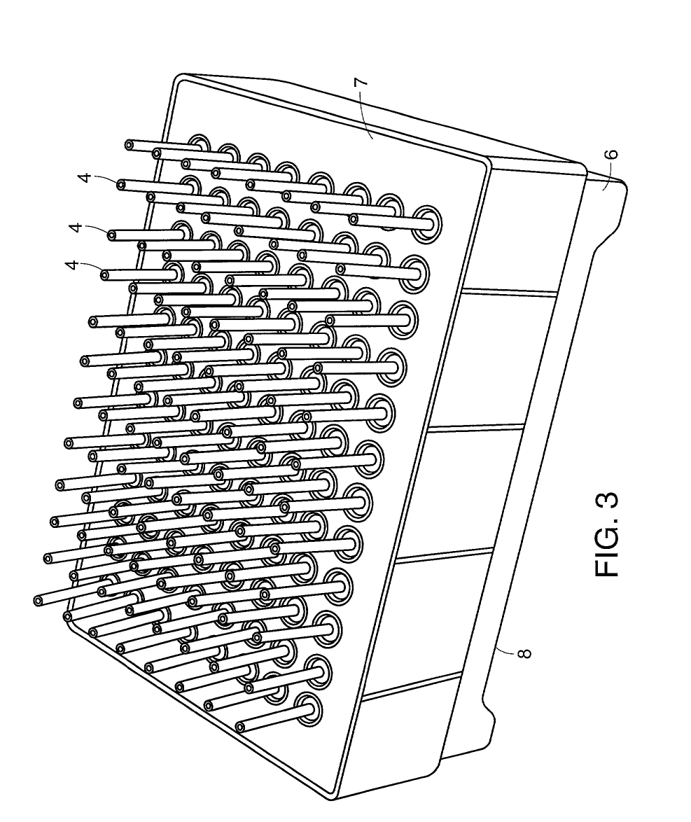

As shown in FIG. 3, multiple dispensers 4 are secured in the wells of the base 6 by a lid 7 having a plurality of holes in register with said wells. Other means for securing dispensers are friction, suction, threads or adhesive. The assembled multi-dispenser apparatus 8 may be in 96 well format as shown or other useful pattern orarray with more or fewer dispensers.

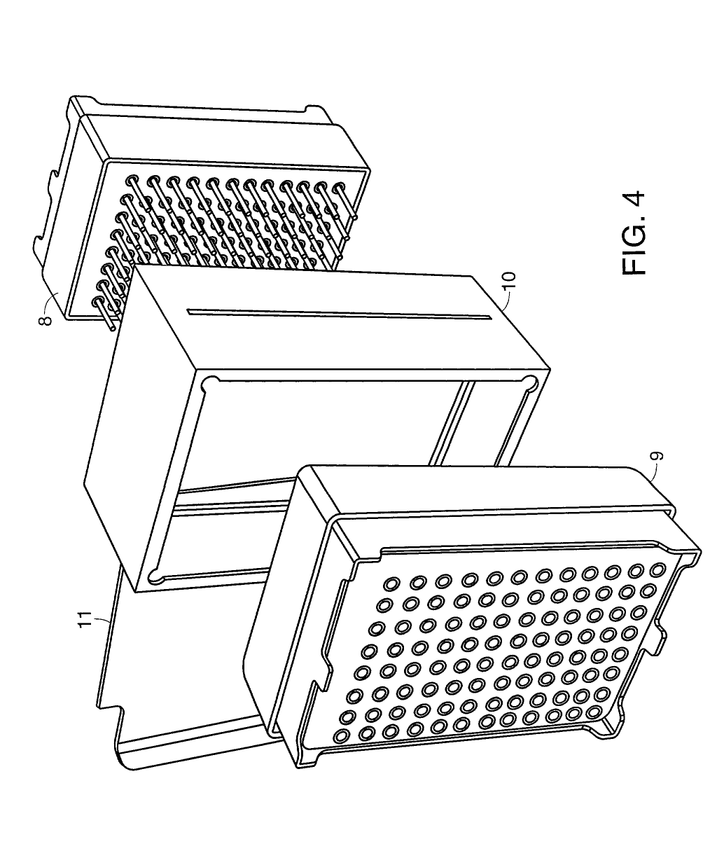

As shown in FIG. 4, the multi-dispenser apparatus 8 is aligned with an array of containers 9 using a valve box 10. One embodiment of an array of containers comprises tubes, e.g. ScreenMates 1.4 mL tubes, secured in the wells of a base by a lid having a plurality of holes in register with said wells. A valve box 10 is a rigid box with two opposing open ends and a groove which holds a sliding plate 11. The open ends can receive a multi-dispenser apparatus and an array of containers. The multi-dispenser apparatus and the array of containers are isolated when the sliding plate 11 is pushed in. When the sliding plate 11 is out, seed dispensers can communicate with aligned containers.

To illustrate the operation of the valve box 10 in the seed transfer apparatus, reference is made to the following steps. The seed containing dispensers in the multi-dispenser apparatus are initially vertical as shown in FIG. 2. One open end of a valve box 10 with sliding plate 11 open is placed onto the multi-dispenser apparatus 8. An array of containers 9 is inverted and placed in the opposite open end of the valve box 10 to align the dispensers in the apparatus with the containers in the array of containers 9. In such alignment, the outside end of each inner tube of a dispenser extends into its aligned container so that each aliquot is dispensed directly into a container without cross contamination. When the assembly is inverted aliquots of seed are dispensed into the containers.

After the aliquots of seeds are dispensed, the inverted multi-dispenser apparatus is raised in the valve box to allow the sliding plate to be pushed in to prevent cross contamination among the dispensed seed aliquots. With the sliding plate 11 separating the multi-dispenser 8 and the array of containers 9, the array of containers can be removed from the valve box 10 and the multi-dispenser can be inverted back to the original vertical position for preparation to dispense more aliquots of seed.

Alternatively, one can transfer seeds from a multi-dispenser apparatus without the use of a valve box. An array of containers is simply placed in alignment over a multi-dispenser apparatus such that the inner tube of individual dispensers communicate with respectively aligned containers. The aligned and communicating assembly of multi-dispenser and array of containers is inverted to dispense seeds. After the aliquots of seeds are dispensed, the multi-dispenser is raised until the extended outer ends of the inner tubes are withdrawn from the containers. A sheet of paper is inserted between the containers and the end of the outer tubes to prevent cross contamination. That is, the sheet of paper serves as the sliding plate of a valve box.

We claim:

1. A dispenser for aliquots of seed, comprising:
(a) a rigid outer tube having a bottom for holding seed and an open end;
(b) a closure for said open end adapted for holding an inner tube; and
(c) a straight inner tube for conducting seed from an inside end proximate to said bottom through said closure to an outside end, wherein said inner tube has a diameter larger than the greatest dimension of Arabidopsis thaliana seed
wherein, when said dispenser is vertically oriented with the bottom down and said outer tube contains a quantity of seed at a level above the inside end of the inner tube, said dispenser can be repeatedly inverted to dispense aliquots of seeds.

2. A dispenser according to claim 1 wherein said closure is a polymeric stopper having a central bore molded to said inner tube.

3. Multi-dispenser apparatus for dispensing a plurality of aliquots of seeds comprising:
(a) a base with a plurality of wells in a fixed pattern
(b) at least one dispenser according to claim 1 in two or more of said wells
(c) means for holding said dispensers in said wells when said base is inverted.

4. Multi-dispenser apparatus of claim 3, wherein means for holding said dispensers in said wells is a lid having a plurality of holes in register with said wells.

5. Apparatus for transferring aliquots of seed to an array of containers, comprising:
(a) a multi-dispenser apparatus according to claim 3 and
(b) an array of containers in the same pattern as the multi-dispenser, wherein dispenser elements of said multi-dispenser are aligned with containers of said array of containers.

6. Apparatus of claim 5 wherein multi-dispenser is aligned with said array of containers in a valve box.

7. Apparatus according to claim 6 wherein said valve box comprises a rigid box with one open end for receiving said multi-dispenser apparatus and an opposing open end for receiving said array of containers and wherein said box has a sliding plate for isolating said multi-dispenser apparatus and said array of containers.

8. A dispenser according to claim 1 further comprising a quantity of seed of Arabidopsis thaliana.

9. A method for dispensing aliquots of seed of Arabidopsis thaliana comprising dispensing said seed from a dispenser of claim 1.
